(19) United States
(12) Patent Application Publication
(10) Pub. No.: US 2018/0297485 A1
(43) Pub. Date: Oct. 18, 2018

(54) METHOD OF CONTROLLING ROLLBACK IN A CONTINUOUSLY VARIABLE TRANSMISSION

(71) Applicant: DANA LIMITED, MAUMEE, OH (US)

(72) Inventors: JEFFREY M. DAVID, CEDAR PARK, TX (US); CHARLES B. LOHR, III, JONESTOWN, TX (US)

(73) Assignee: DANA LIMITED, MAUMEE, OH (US)

(21) Appl. No.: 15/766,946

(22) PCT Filed: Oct. 6, 2016
(86) PCT No.: PCT/US2016/055728

§ 371 Date: Apr. 9, 2018

Related U.S. Application Data
(60) Provisional application No. 62/239,347, filed on Oct. 9, 2015.

(51) Int. Cl. B60L 15/20; F16H 61/66; F16H 15/28; B60W 10/18

(52) U.S. Cl. CPC B60L 15/2054; F16H 61/66; B60L 2240/486; B60W 10/18; F16H 15/28

(57) ABSTRACT

A control system for a vehicle having an infinitely variable transmission (IVT) having a ball planetary variator (CVP), providing a smooth and controlled operation. In some embodiments, the control system implements a rollback prevention sub-module. The rollback prevention sub-module is adapted to receive a number of signals, for example, a signal indicative of a transmission output shaft speed and a signal indicative of a commanded CVP shift actuator position. In some embodiments, the rollback prevention sub-module determines a correction value to be applied to the commanded CVP shift actuator position. The correction value is based at least in part on the transmission output shaft speed signal. In some embodiments, the rollback prevention sub-module is adapted to monitor and determine the deactivation of a CVP shift actuator.

### CROSS-REFERENCE

The present application claims the benefit of U.S. Provisional Application No. 62/239,347, filed Oct. 9, 2015, which is incorporated herein by reference in its entirety.

### BACKGROUND OF THE INVENTION

Infinitely variable transmissions (IVT) and continuously variable transmissions (CVT) are becoming more in demand for a variety of vehicles as they offer performance and efficiency improvements over standard fixed gear transmissions. Certain types of IVTs and CVTs that employ ball-type continuously variable planetary (CVP) transmissions often have shift actuators coupled to the CVP for control of speed ratio during operation of the transmission. Implementation of an IVT into a vehicle can improve vehicle performance and efficiency. However, some continuously variable transmissions have unique operating characteristics compared to traditional geared transmissions. It is desirable for the transmission control system to manage the IVT under all operating conditions the vehicle will encounter. Therefore a new control method is needed to control the IVT in the presence of a rollback condition.

### SUMMARY OF THE INVENTION

Provided herein is a computer-implemented system for a vehicle having an engine coupled to an infinitely variable transmission having a ball-planetary variator (CVP), the CVP having a plurality of balls, each ball provided with a tiltable axis or rotation, each ball supported in a carrier assembly, the carrier assembly operably coupled to a shift actuator, the computer-implemented system comprising: a digital processing device comprising an operating system configured to perform executable instructions and a memory device; a computer program including instructions executable by the digital processing device comprising a software module configured to manage a plurality of vehicle driving conditions; a plurality of sensors comprising: a transmission output shaft speed sensor configured to sense a transmission output shaft speed, and a CVP shift actuator position sensor configured to sense a CVP shift actuator position; wherein the software module is adapted to determine a commanded CVP shift actuator position based at least in part on the transmission output shaft speed and the CVP shift actuator position. In some embodiments of the computer-implemented system, the software module further comprises a calibration map, the calibration map configured to store values of a CVP shift actuator position correction signal based at least in part on the transmission output shaft speed. In some embodiments of the computer-implemented system, the software module further comprises a shift actuator deactivate signal, the shift actuator deactivate signal based at least in part on the transmission output shaft speed. In some embodiments of the computer-implemented system, the software module further comprises a rollback active signal, the rollback active signal based at least in part on the transmission output shaft speed. In some embodiments of the computer-implemented system, a first speed threshold calibration variable, the first speed threshold calibration variable indicative of a minimum value for the transmission output shaft speed. In some embodiments of the computer-implemented system, the software module further comprises a comparison of the first speed threshold calibration variable to the transmission output shaft speed. In some embodiments of the computer-implemented system, the rollback active signal is based at least in part on the comparison of the first speed threshold calibration variable to the transmission output shaft speed. In some embodiments of the computer-implemented system, a second speed threshold calibration variable, the second speed threshold calibration variable indicative of a transmission output shaft speed are associated with a sustained reverse rotation. In some embodiments of the computer-implemented system, the shift actuator deactivate signal is based at least in part on the second speed threshold calibration variable. In some embodiments of the computer-implemented system, a corrected commanded CVP shift actuator position signal is based at least in part on the CVP shift actuator position correction signal, the CVP shift actuator position, and the rollback active signal. In some embodiments of the computer-implemented system, the stored values of the CVP actuator position are positive values. In some embodiments of the computer-implemented system, the stored values of the CVP actuator position are indicative of a shift towards an overdrive condition of the CVP. In some embodiments of the computer-implemented system, the corrected commanded CVP shift actuator position signal is increased until reverse rotation approaches zero speed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a block diagram of a powertrain having an infinitely or continuously variable transmission (IVT) controlled by a transmission controller and used in a vehicle.

FIG. 5 is a block diagram schematic of a software module that is implemented in a vehicle having a shift actuator and a transmission controller.

FIG. 6 is a flow chart depicting a rollback prevention process that is implementable on the powertrain of FIG. 4.

FIG. 7 is a graph depicting an illustrative example of a calibration table or map that is implementable in the software module of FIG. 5.

### DETAILED DESCRIPTION OF THE INVENTION

Described herein is a control system for a vehicle having an infinitely variable transmission (IVT) having a ball planetary variator (CVP), providing a smooth and controlled operation. In some embodiments, the control system implements a rollback prevention sub-module. The rollback prevention sub-module is adapted to receive a number of signals, for example, a signal indicative of a transmission output shaft speed and a signal indicative of a commanded CVP shift actuator position. In some embodiments, the rollback prevention sub-module determines a correction value to be applied to the commanded CVP shift actuator position. The correction value is based at least in part on the transmission output shaft speed signal. In some embodiments, the rollback prevention sub-module is adapted to monitor and determine the deactivation of a CVP shift actuator.

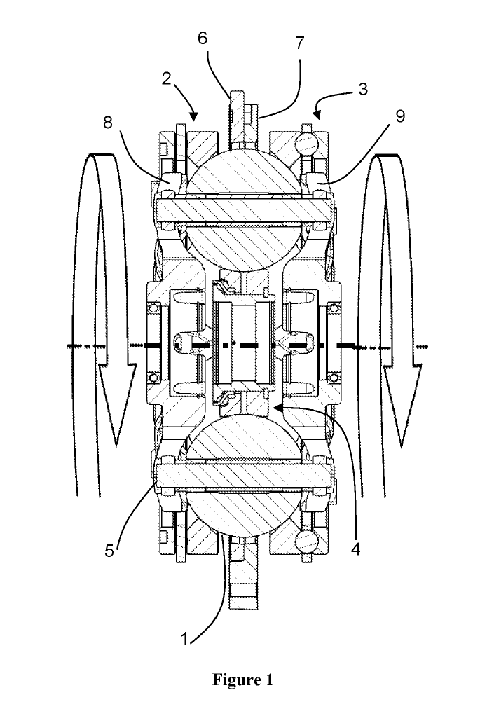

Provided herein are configurations of CVTs based on ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls, as input ring 2 and output ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 can be substantially fixed from rotation while the second carrier member 7 is configured to rotate with respect to the first carrier member, and vice versa. In some embodiments, the first carrier member 6 is provided with a number of radial guide slots 8. The second carrier member 9 is provided with a number of radially offset guide slots 9. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first carrier member and the second carrier member to impart a tilting of the axles 5 and thereby adjusts the speed ratio of the variator. Other types of ball CVTs also exist, like the one produced by Milner, but are slightly different.

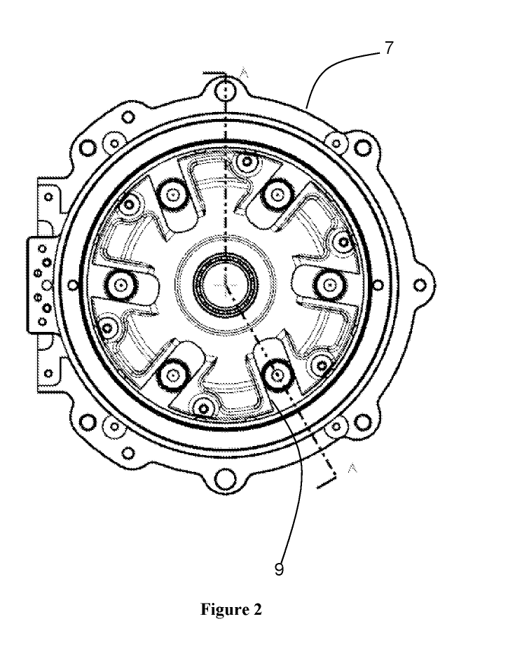

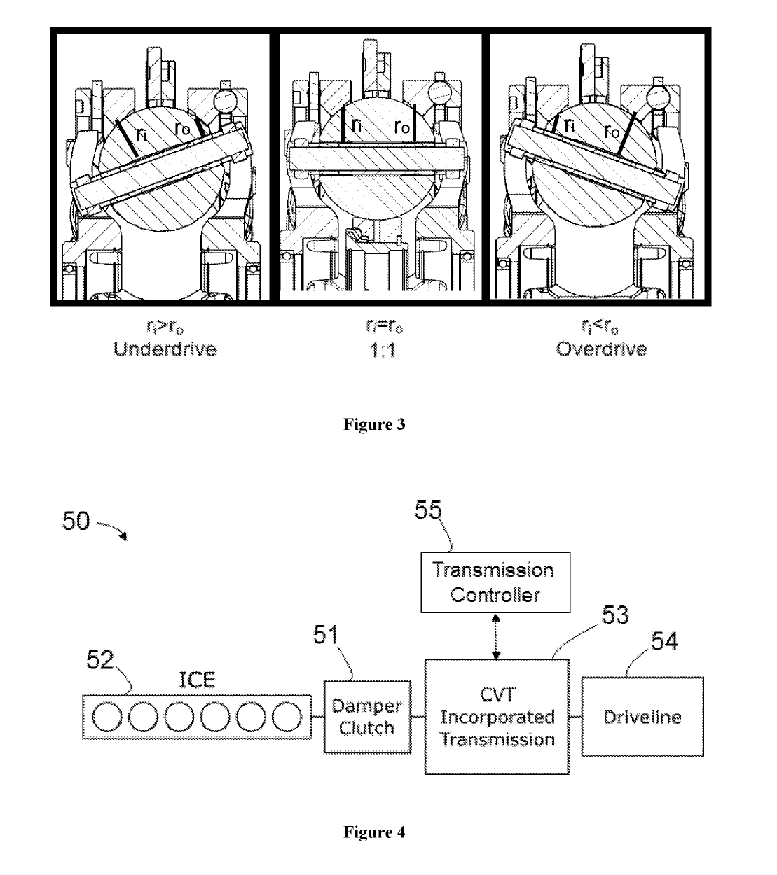

The working principle of such a CVP of FIG. 1 is shown on FIG. 2. The CVP itself works with a traction fluid. The lubricant between the ball and the conical rings acts as a solid at high pressure, transferring the power from the input ring, through the balls, to the output ring. By tilting the balls' axes, the ratio can be changed between input ring and output ring. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments of the invention disclosed here are related to the control of a variator and/or a CVT using generally spherical planets each having a tiltable axis of rotation that can be adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In some embodiments, a control system coordinates the use of a skew angle to generate forces between certain contacting components in the variator that will tilt the planet axis of rotation. The tilting of the planet axis of rotation adjusts the speed ratio of the variator. It should be noted that a skew shifted CVT having radially offset guide slots 9, for example, has an inherent characteristic that when rotated in opposite direction of design intent, the slot angle feedback mechanism becomes positive and will drive planet axles towards full OD and lock the unit. Therefore it is desirable to implement a method of control to prevent lock up in the CVP during operation.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

It should be noted that reference herein to “traction” does not exclude applications where the dominant or exclusive mode of power transfer is through “friction.” Without attempting to establish a categorical difference between traction and friction drives here, generally these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here will operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source may be fueled by energy sources comprising hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission comprising this technology.

For description purposes, the terms “electronic control unit”, “ECU”, “Driving Control Manager System” or “DCMS” are used interchangeably herein to indicate a vehicle's electronic system that controls subsystems monitoring or commanding a series of actuators on an internal combustion engine to ensure optimal engine performance. It does this by reading values from a multitude of sensors within the engine bay, interpreting the data using multidimensional performance maps (called lookup tables), and adjusting the engine actuators accordingly. Before ECUs, air-fuel mixture, ignition timing, and idle speed were mechanically set and dynamically controlled by mechanical and pneumatic means.

Those of skill will recognize that brake position and throttle position sensors are electronic, and in some cases, well-known potentiometer type sensors. These sensors provide a voltage or current signal that is indicative of a relative rotation and/or compression/depression of driver control pedals, for example, brake pedal and/or throttle pedal. Often, the voltage signals transmitted from the sensors are scaled. A convenient scale used in the present application as an illustrative example of one implementation of the control system uses a percentage scale 0%-100%, where 0% is indicative of the lowest signal value, for example a pedal that is not compressed, and 100% is indicative of the highest signal value, for example a pedal that is fully compressed. In some embodiments, T there may be implementations of the control system where the brake pedal is effectively fully engaged with a sensor reading of 20%-100%. Likewise, in some embodiments, a fully engaged throttle pedal corresponds to a throttle position sensor reading of 20%-100%. The sensors, and associated hardware for transmitting and calibrating the signals, are optionally selected in such a way as to provide a relationship between the pedal position and signal to suit a variety of implementations. Numerical values given herein are included as examples of one implementation and not intended to imply limitation to only those values. For example, in some embodiments, a minimum detectable threshold for a brake pedal position is 6% for a particular pedal hardware, sensor hardware, and electronic processor. Whereas an effective brake pedal engagement threshold is 14%, and a maximum brake pedal engagement threshold begins at or about 20% compression. As a further example, in some embodiments, a minimum detectable threshold for an accelerator pedal position is 5% for a particular pedal hardware, sensor hardware, and electronic processor. In some embodiments, similar or completely different pedal compression threshold values for effective pedal engagement and maximum pedal engagement are also applied for the accelerator pedal.

As used herein, and unless otherwise specified, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 30%, 25%, 20%, 15%, 10%, 9%, 8%, 7%, 6%, 5%, 4%, 3%, 2%, 1%, 0.5%, 0.1%, or 0.05% of a given value or range. in certain embodiments, the term “about” or “approximately” means within 40.0 mm, 30.0 mm, 20.0 mm, 10.0 mm 5.0 mm 1.0 mm, 0.9 mm, 0.8 mm, 0.7 mm, 0.6 mm, 0.5 mm, 0.4 mm, 0.3 mm, 0.2 mm or 0.1 mm of a given value or range. In certain embodiments, the term “about” or “approximately” means within 20. degrees, 15.0 degrees, 10.0 degrees, 9.0 degrees, 8.0 degrees, 7.0 degrees, 6.0 degrees, 5.0 degrees, 4.0 degrees, 3.0 degrees, 2.0 degrees, 1.0 degrees, 0.9 degrees, 0.8 degrees, 0.7 degrees, 0.6 degrees, 0.5 degrees, 0.4 degrees, 0.3 degrees, 0.2 degrees, 0.1 degrees, 0.05 degrees of a given value or range.

In certain embodiments, the term “about” or “approximately” means within 5.0 mA, 1.0 mA, 0.9 mA, 0.8 mA, 0.7 mA, 0.6 mA, 0.5 mA, 0.4 mA, 0.3 mA, 0.2 mA, 0.1 mA, 0.09 mA, 0.08 mA, 0.07 mA, 0.06 mA, 0.05 mA, 0.04 mA, 0.03 mA, 0.02 mA or 0.01 mA of a given value or range.

As used herein, “about” when used in reference to a velocity of the moving object or movable substrate means variation of 1%-5%, of 5%-10%, of 10%-20%, and/or of 10%-50% (as a percent of the percentage of the velocity, or as a variation of the percentage of the velocity). For example, in some embodiments, if the percentage of the velocity is “about 20%”, the percentage may vary 5%-10% as a percent of the percentage i.e. from 19% to 21% or from 18% to 22%; alternatively the percentage may vary 5%-10% as an absolute variation of the percentage i.e. from 15% to 25% or from 10% to 30%.

In certain embodiments, the term “about” or “approximately” means within 0.01 sec., 0.02 sec, 0.03 sec., 0.04 sec., 0.05 sec., 0.06 sec., 0.07 sec., 0.08 sec. 0.09 sec. or 0.10 sec of a given value or range. In certain embodiments, the term “about” or “approximately” means within 0.5 rpm/sec, 1.0 rpm/sec, 5.0 rpm/sec, 10.0 rpm/sec, 15.0 rpm/sec, 20.0 rpm/sec, 30 rpm/sec, 40 rpm/sec, or 50 rpm/sec of a given value or range.

Those of skill will recognize that in some embodiments, the various illustrative logical blocks, modules, circuits, and algorithm steps described in connection with the embodiments disclosed herein, including with reference to the transmission control system described herein, for example, are implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, various illustrative logical blocks, modules, and circuits described in connection with the embodiments disclosed herein are implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. In some embodiments, a processor will be implemented as a combination of computing devices, e.g., a combination of a DSP and a microprocessor, a plurality of microprocessors, one or more microprocessors in conjunction with a DSP core, or any other such configuration. In some embodiments, software associated with such modules resides in RAM memory, flash memory, ROM memory, EPROM memory, EEPROM memory, registers, a hard disk, a removable disk, a CD-ROM, or any other suitable form of storage medium known in the art. In some embodiments, an exemplary storage medium is coupled to the processor such that the processor reads information from, and writes information to, the storage medium. In alternative embodiments, the storage medium is integral to the processor. In some embodiments, the processor and the storage medium reside in an ASIC. For example, in some embodiments, a controller for use of control of the IVT comprises a processor (not shown).

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Digital Processing Device

In some embodiments, the Control System for a Vehicle equipped with an infinitely variable transmission described herein includes a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments the Control System for a Vehicle equipped with an infinitely variable transmission disclosed herein includes one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the Control System for a Vehicle equipped with an infinitely variable transmission disclosed herein includes at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof

Referring now to FIG. 4, in some embodiments, a vehicle is equipped with a powertrain 50 having a torsional damper 51 between an engine 52 and an infinitely or continuously variable transmission (IVT) 53 to avoid transferring torque peaks and vibrations that could damage the IVT 53 (called variator in this context as well). In some embodiments, the IVT 53 includes a variator of the type described in reference to FIGS. 1-3. In some embodiments, the IVT 53 is coupled to a driveline 54 that includes a number of fixed ratio gearing or other means to couple a rotational power output from the IVT 53 to drive wheels of a vehicle (not shown). In some configurations this damper is optionally coupled with a clutch for the starting function or to allow the engine 52 to be decoupled from the transmission. In other embodiments, a torque converter (not shown), is used to couple the engine 52 to the IVT 53. Other types of IVT's (apart from ball-type traction drives) are optionally used as the variator in this layout. In addition to the configurations above where the variator is used directly as the primary transmission, other architectures are possible. Various powerpath layouts are introduced by adding a number of gears, clutches and simple or compound planetaries. In such configurations, the overall transmission will provide several operating modes; a CVT, an IVT, a combined mode and so on. A control system, a transmission controller 55, for use in an infinitely or continuously variable transmission will now be described. It should be appreciated that the transmission controller 55 is optionally configured as an electro-mechanical device having a number of sensors, actuators, and computer-implemented software modules configured to monitor and control the powertrain 50.

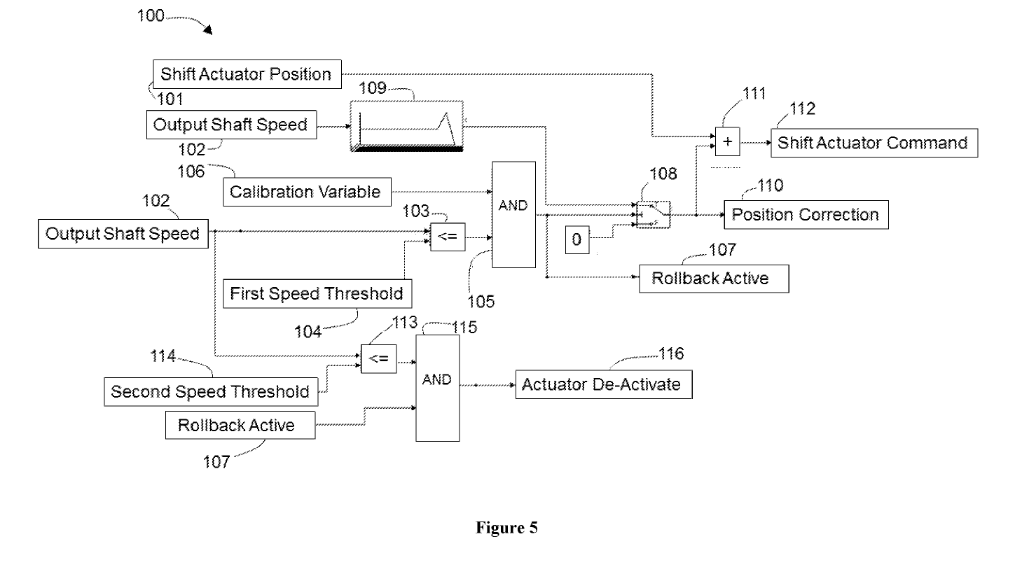

Referring now to FIG. 5, in some embodiments, a rollback prevention sub-module 100, sometimes referred to herein as “software module” is used in the transmission controller 55 configured to control the operation of the CVP and/or driveline depicted in FIG. 4. For clarity and conciseness, only certain aspects of the transmission controller 55 are described. It should be appreciated, that the transmission controller 55 is configured to receive and send a number of signals indicative of operating conditions in the powertrain 50 and/or vehicle in order to control the IVT 53, among other components of the powertrain 50. In some embodiments, the rollback prevention sub-module 100 is adapted to receive a commanded shift actuator position signal 101 and a transmission output shaft speed signal 102. The commanded shift actuator position signal 101 is determined by the transmission controller and/or a sub-module of the transmission controller. In some embodiments, the commanded shift actuator position signal 101 is based at least in part on desired operating conditions of the CVP. In some embodiments, the commanded shift actuator position signal 101 is based at least in part on current operation conditions of the CVP, for example, a current CVP shift actuator position. The transmission output shaft speed signal 102 is compared at a first comparison block, 103 to a first speed threshold calibration variable 104. The result of the first comparison block, 103 is passed to a first Boolean block, 105 that evaluates a calibration variable 106 to determine a rollback active signal 107. In some embodiments, the calibration variable 106 is indicative of an enable command for implementing rollback prevention. If the first comparison block, 103 and the calibration variable 106 have true values, the first Boolean block, 105 passes a true value of the rollback active signal 107 to a switch block 108. If the first comparison block 103 and the calibration variable 106 have false values, the first Boolean block 105 passes a false value for the rollback active signal 107 to the switch block 108. The switch block 108 is configured to receive a signal from a calibration map 109. The calibration map 109 receives the transmission output shaft speed signal 102. The calibration map 109 is adapted to store values for a CVP shift actuator position correction signal 110 based at least in part on the transmission output shaft speed signal 102. When the rollback active signal 107 is true, the switch block 108 passes the CVP shift actuator position correction signal 110 to a summing block 111 to form a corrected commanded CVP shift actuator position signal 112.

In some embodiments, the rollback prevention sub-module 100 includes a second comparison block 113 that compares the transmission output shaft speed signal 102 to a second speed threshold calibration variable 114. In some embodiments, the second speed threshold calibration variable 114 is indicative of a transmission output shaft speed associated with sustain reverse rotation. The second comparison block 113 passes a signal to a second Boolean block 115. If the second comparison block 113 passes a true value and the rollback active signal 107 is true, the second Boolean block 115 passes a true value for a shift actuator deactivate signal 116. If the second comparison block 113 passes a false value or the rollback active signal 107 is a false value, the second Boolean block 115 passes a false value for the shift actuator deactivate signal 116.

During operation of the CVP, in some embodiments, operating conditions occur that result in a negative or reverse rotation of the transmission output shaft speed signal 102. For example, in some embodiments, a driver will position the vehicle equipped with the CVP on a hill or incline and release the brake pedal. The vehicle will roll backwards down the hill or incline with the transmission engaged thereby turning the transmission output shaft in a reverse direction. For example, in other embodiments, the driver selects a reverse gear on a gear lever, such as a well-known “PRNDL” gear selector. The vehicle will roll backwards in a reverse operating mode and thereby turn the transmission output shaft in a reverse direction. In some embodiments, transmission lock up will occur when the direction of rotation of the CVP components is the reverse of the design direction of rotation. The transmission controller implements the rollback prevention sub-module 100 to detect the onset of reverse rotation and adjust the shift actuator position to compensate. If sustained reverse rotation is detected, the rollback prevention sub-module 100 disengages or shuts off the shift actuator to thereby allow the shifting mechanism to free wheel. Under certain conditions, the shift actuator is commanded to move the CVP towards an overdrive ratio when reverse rotation is detected. If reverse rotation is sustained based on the calibrateable threshold such as the second speed threshold calibration variable 114, the shift actuator is commanded to disengage or disable the shift actuator. During operation, if a reverse rotation speed changes, for example decreases in reverse speed as compared to an initial detection of reverse rotation, the shift actuator is commanded to increase the correction applied to the position of the CVP towards an overdrive ratio as the CVP approaches zero speed from the reverse direction to account for the case of a potential second reverse rotation without crossing the positive speed direction.

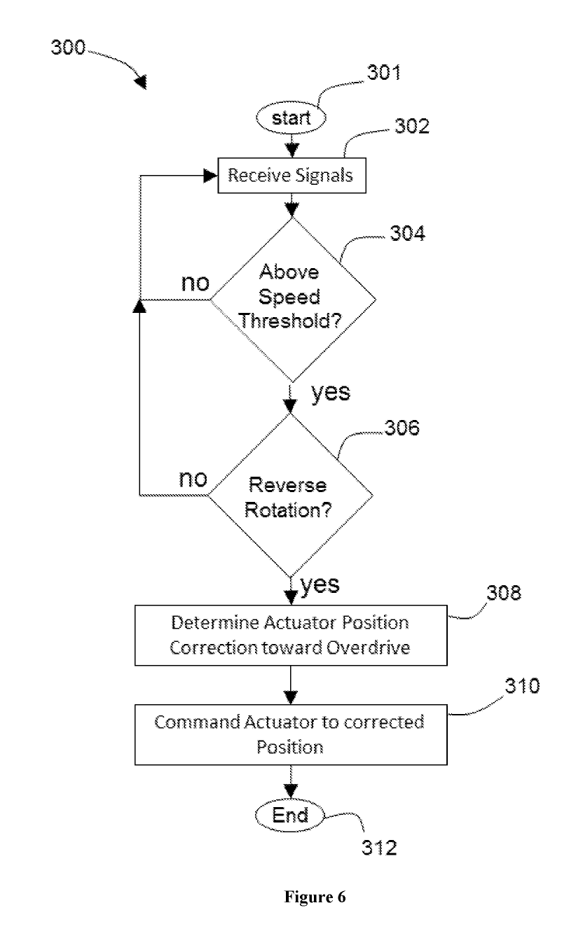

Referring now to FIG. 6, in some embodiments a control process 300 is implemented in the transmission controller 55. The control process 300 begins at a start state 301 and proceeds to a block 302 where a number of signals are received. In some embodiments, the signals received are indicative of a transmission output speed, a current shift actuator position, among others. The control process 300 proceeds to a first evaluation block 304 where the transmission output speed is compared to a speed threshold. If the transmission output speed is below the speed threshold, the first evaluation block 304 returns a false value, and the control process 300 returns to the block 302. If the transmission output speed is above the speed threshold, the first evaluation block 304 returns a true value, and the control process 300 proceeds to a second evaluation block 306. The second evaluation block 306 evaluates the direction of rotation of the transmission output speed. If the direction of rotation is in a forward direction, the second evaluation block 306 returns a false value, and the control process 300 returns to the block 302. If the direction of rotation of the transmission output speed is in a reverse direction, the second evaluation block 306 returns a true value, and the control process 300 proceeds to a block 308 where an actuator position correction is determined. The actuator position correction is indicative of a change in shift actuator position toward an overdrive condition. The control process 300 proceeds to a block 310 where a command is issued to move the shift actuator to the corrected position. The control process 300 ends at a state 312.

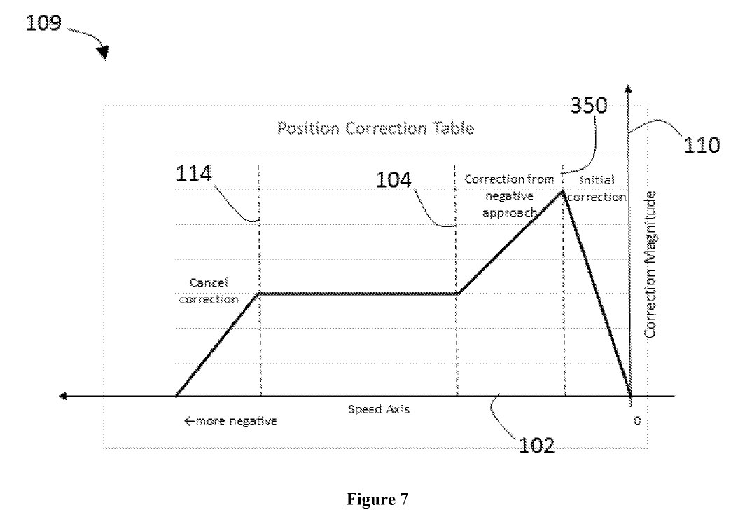

Turning now to FIG. 7, in some embodiments, the calibration map 109 is depicted as a chart having an x-axis representing the transmission output shaft speed 102 and a y-axis representing the shift actuator position correction signal 110. The first speed threshold calibration variable 104 and the second speed threshold calibration variable 114 are depicted as a vertical lines on the chart in FIG. 7. In some embodiments, the shift actuator position correction signal 110 is substantially a constant value between the first speed threshold calibration variable 104 and the second speed threshold calibration variable 114. For transmission output shaft speeds 102 more negative in magnitude than the second speed threshold calibration variable 114, the shift actuator is disabled. In some embodiments, a third speed threshold calibration variable 350, represented by a vertical line in FIG. 7, is implemented in the calibration map 109. For the transmission output shaft speed 102 between zero speed and the third speed threshold calibration variable 350, the magnitude of the shift actuator position correction signal 110 increases from zero to a maximum value at the third speed threshold calibration variable 350. For the transmission output shaft speed 102 between the third speed threshold calibration variable 350 and the first speed threshold calibration variable 104, the magnitude of the shift actuator position correction signal 110 decreases from the maximum value to a non-zero value at the first speed threshold calibration variable 104. It should be noted that the magnitude of the shift actuator position correction signal 110 is positive and delivers a change in the shift actuator position towards an overdrive condition of the CVP.

Provided herein is a computer-implemented system for a vehicle having an engine coupled to an infinitely variable transmission having a ball-planetary variator (CVP), the CVP having a plurality of balls, each ball provided with a tiltable axis or rotation, each ball supported in a carrier assembly, the carrier assembly operably coupled to a shift actuator, the computer-implemented system comprising: a digital processing device comprising an operating system configured to perform executable instructions and a memory device; a computer program including instructions executable by the digital processing device comprising a software module configured to manage a plurality of vehicle driving conditions; a plurality of sensors comprising: a transmission output shaft speed sensor configured to sense a transmission output shaft speed, and a CVP shift actuator position sensor configured to sense a CVP shift actuator position; wherein the software module is adapted to determine a commanded CVP shift actuator position based at least in part on the transmission output shaft speed and the CVP shift actuator position.

In some embodiments of the computer-implemented system, the software module further comprises a calibration map, the calibration map configured to store values of a CVP shift actuator position correction signal based at least in part on the transmission output shaft speed. In some embodiments of the computer-implemented system, the software module further comprises a shift actuator deactivate signal, the shift actuator deactivate signal based at least in part on the transmission output shaft speed. In some embodiments of the computer-implemented system, the software module further comprises a rollback active signal, the rollback active signal based at least in part on the transmission output shaft speed. In some embodiments of the computer-implemented system, a first speed threshold calibration variable, the first speed threshold calibration variable indicative of a minimum value for the transmission output shaft speed. In some embodiments of the computer-implemented system, the software module further comprises a comparison of the first speed threshold calibration variable to the transmission output shaft speed. In some embodiments of the computer-implemented system, the rollback active signal is based at least in part on the comparison of the first speed threshold calibration variable to the transmission output shaft speed. In some embodiments of the computer-implemented system, a second speed threshold calibration variable, the second speed threshold calibration variable indicative of a transmission output shaft speed are associated with a sustained reverse rotation. In some embodiments of the computer-implemented system, the shift actuator deactivate signal is based at least in part on the second speed threshold calibration variable. In some embodiments of the computer-implemented system, a corrected commanded CVP shift actuator position signal is based at least in part on the CVP shift actuator position correction signal, the CVP shift actuator position, and the rollback active signal. In some embodiments of the computer-implemented system, the stored values of the CVP actuator position are positive values. In some embodiments of the computer-implemented system, the stored values of the CVP actuator position are indicative of a shift towards an overdrive condition of the CVP. In some embodiments of the computer-implemented system, the corrected commanded CVP shift actuator position signal is increased until reverse rotation approaches zero speed.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as any one claim makes a specified dimension, or range of thereof, a feature of the claim.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1-13. (canceled)

14. A method for controlling rollback in a continuously variable transmission having a ball-planetary variator (CVP), the CVP having a plurality of balls, each ball provided with a tiltable axis or rotation, each ball supported in a carrier assembly, the carrier assembly operably coupled to a CVP shift actuator and a plurality of sensors, the method comprising the steps of:
receiving signals from one or more of the sensors indicative of a transmission output shaft speed and a CVP shift actuator position;
determining a commanded CVP shift actuator position based at least in part on the transmission output shaft speed and the CVP shift actuator position;
determining a correction value to the commanded CVP shift actuator position based at least in part on the transmission output shaft speed; and
commanding a change in the CVP shift actuator position based on the correction value.

15. The method of claim 14, further comprising the steps of:
comparing the transmission output shaft speed to a first speed threshold calibration variable; and
determining a rollback active signal based at least in part on the comparison of the first speed threshold calibration variable to the transmission output shaft speed,
wherein the first speed threshold calibration variable indicative of a minimum value for the transmission output shaft speed.

16. The method of claim 14, further comprising the steps of:
comparing the transmission output shaft speed to a second speed threshold calibration variable; and
determining a CVP shift deactivation signal based on the comparison of the transmission output shaft speed to the second speed threshold calibration variable,
wherein the second speed threshold calibration variable indicative of a transmission output shaft speed associated with a sustained reverse rotation.

17. The method of claim 15, wherein the step of determining a correction value to the commanded CVP shift actuator position based at least in part on the CVP shift actuator position correction value, the CVP shift actuator position, and the rollback active signal.

18. The method of claim 14, wherein the step of determining a correction value to the commanded CVP shift actuator position based at least in part on a calibration map configured to store values of a CVP shift actuator position correction signal based at least in part on the transmission output shaft speed.

19. The method of claim 18, wherein the stored values of the CVP actuator position are positive values.

20. The method of claim 19, wherein the stored values of the CVP actuator position are indicative of a shift towards an overdrive condition of the CVP.

21. The method of claim 16, wherein change in the CVP shift actuator position is increased until reverse rotation approaches zero speed.
